(19) United States
(12) Patent Application Publication
(10) Pub. No.: US 2015/0210811 A1
(43) Pub. Date: Jul. 30, 2015

(54) CARBON NANOMATERIAL, CARBON NANOMATERIAL-POLYMER COMPOSITE MATERIAL, CARBON FIBER-CARBON NANOMATERIAL-POLYMER COMPOSITE MATERIAL, AND METHODS OF PREPARING THE SAME

(71) Applicant: Korea Advanced Institute of Science and Technology, Daejeon (KR)

(72) Inventors: Soon Hyung Hong, Daejeon (KR); Sung Hwan Jin, Daejeon (KR); Jae Min Cha, Daejeon (KR); Jae won Hwang, Daejeon (KR); Dong ju Lee, Daejeon (KR)

(21) Appl. No.: 14/607,450

(22) Filed: Jan. 28, 2015

(30) Foreign Application Priority Data
Jan. 29, 2014 (KR) 10-2014-0011454
Jan. 5, 2015 (KR) 10-2015-0000630

(51) Int. Cl. C08J 5/04; C08F 112/14

(52) U.S. Cl. CPC C08J 5/042; C08F 112/14; C08J 2325/18; C08J 2363/00

(57) ABSTRACT

The present invention relates to a carbon nanomaterial, a carbon nanomaterial-polymer composite material and a carbon fiber-carbon nanomaterial-polymer composite material including the carbon nanomaterial, and methods of preparing the same, and more particularly, to a carbon nanomaterial functionalized by a functional molecule including both an aromatic hydrocarbon ring and a polar group through mechanical milling, a carbon nanomaterial-polymer composite material and a carbon fiber-carbon nanomaterial-polymer composite material including the carbon nanomaterial, and methods of preparing the same.

### CROSS-REFERENCE TO RELATED APPLICATIONS

This application claims the benefit under 35 U.S.C. §119 of Korean Patent Application Nos. 10-2014-0011454, filed Jan. 29, 2014; and 10-2015-0000630, filed Jan. 5, 2015 the disclosures of which are incorporated herein by reference in their entirety.

### BACKGROUND

1. Field of the Invention

Embodiments of the present invention relate to a carbon nanomaterial, a carbon nanomaterial-polymer composite material and a carbon fiber-carbon nanomaterial-polymer composite material including the carbon nanomaterial, and methods of preparing the same, and more particularly, to a carbon nanomaterial functionalized by a functional molecule including both an aromatic hydrocarbon ring and a polar group through mechanical milling, a carbon nanomaterial-polymer composite material and a carbon fiber-carbon nanomaterial-polymer composite material including the carbon nanomaterial, and methods of preparing the same.

2. Description of the Related Art

Carbon nanotubes (CNTs) and graphene are nanometer-thick and micrometer-long carbon nanomaterials with excellent mechanical strength (CNTs: 20 GPa to 50 GPa, graphene: 135 GPa), elasticity (CNTs: 0.8 TPa to 1 TPa, graphene: 0.6 TPa to 1.2 TPa) and flexibility as compared with traditional materials, and prove to considerably improve physical properties of composite materials when used as reinforcing agents for preparing the composite materials. For example, Eric et al. disclose in a paper a CNT-reinforced composite material with improved tensile strength by adding CNTs [Eric W. Wong, Paul E. Sheehan, Charles M. Lieber, “Nanobeam Mechanics: Elasticity, Strength, and Toughness of Nanorods and Nonotubes”, Science 277, 1971 (1997)].

However, carbon nanomaterial composite materials do not properly exhibit own physical properties due to the following two problems: agglomeration of carbon nanomaterials and weak interfacial bond between carbon nanomaterials and a matrix. Carbon nanomaterials easily form agglomerates in a matrix due to high van der Walls force and reduce physical properties of the composite materials. Further, carbon nanomaterials do not form a strong bond with a matrix material because of basically inactive surface and thus transfer of stress and charges between the carbon nanomaterials and the matrix is restricted.

### BRIEF SUMMARY

An aspect of the present invention provides to a carbon nanomaterial, a carbon nanomaterial-polymer composite material and a carbon fiber-carbon nanomaterial-polymer composite material including the carbon nanomaterial, and methods of preparing the same.

Technical subjects to be solved by the present disclosure are not restricted to the above-mentioned description, and any other technical problems not mentioned so far will be clearly appreciated from the following description by the skilled in the art.

A first aspect of the present invention provides a carbon nanomaterial functionalized by a functional molecule including both an aromatic hydrocarbon ring and a polar group through mechanical milling.

The mechanical milling may include ball milling, planetary milling, attrition milling, jet milling or bead milling.

The polar group may include at least one selected from the group consisting of —NH₂, —OH, —SO₃⁻, an amide group (—CONH₂), an amide group substituted with a C1 to C10 alkyl group (—CONHR), a halo group, a carbonyl group substituted with a C1 to C10 alkyl group (—COR), an aldehyde group (—COH), a carboxyl group (—COOH), an ester group substituted with a C1 to C10 alkyl group (—COOR), a nitrile group (—CN) and a nitro group (—NO₂).

The carbon nanomaterial may include a functionalized carbon nanotube (CNT), a functionalized carbon fiber, a functionalized carbon nanorod or a functionalized graphene.

A second aspect of the present invention provides a method of preparing a carbon nanomaterial, the method including forming a mixture by mixing a functional molecule including both an aromatic hydrocarbon ring and a polar group with a carbon nanomaterial; and acquiring a functionalized carbon nanomaterial by conducting mechanical milling on the mixture.

The polar group may include at least one selected from the group consisting of —NH₂, —OH, —SO₃⁻, an amide group (—CONH₂), an amide group substituted with a C1 to C10 alkyl group (—CONHR), a halo group, a carbonyl group substituted with a C1 to C10 alkyl group (—COR), an aldehyde group (—COH), a carboxyl group (—COOH), an ester group substituted with a C1 to C10 alkyl group (—COOR), a nitrile group (—CN) and a nitro group (—NO₂).

The functionalized carbon nanomaterial may include a functionalized CNT, a functionalized carbon fiber, a functionalized carbon nanorod or a functionalized graphene.

The mechanical milling may include ball milling, planetary milling, attrition milling, jet milling or bead milling.

A third aspect of the present invention provides a carbon nanomaterial-polymer composite material including a polymer matrix and the carbon nanomaterial according to the first aspect.

The polymer matrix may include a thermosetting polymer or a thermoplastic polymer.

The thermosetting polymer may include at least one selected from the group consisting of an epoxy resin, a phenolic resin, a urethane resin and an unsaturated ester resin.

The thermoplastic polymer may include at least one selected from the group consisting of a nylon resin, a polyester resin and a polycarbonate resin.

A fourth aspect of the present invention provides a method of preparing a carbon nanomaterial-polymer composite material including mixing a carbon nanomaterial prepared by the method according to the second aspect with a polymer matrix.

The mixing may further include adding a curing agent.

A fifth aspect of the present invention provides a carbon fiber-carbon nanomaterial-polymer composite material including a carbon fiber and the carbon nanomaterial-polymer composite material according to the third aspect.

The carbon fiber-carbon nanomaterial-polymer composite material may have a single-layer or multilayer structure.

A sixth aspect of the present invention provides a method of preparing a carbon fiber-carbon nanomaterial-polymer composite material including impregnating a carbon fiber with the carbon nanomaterial-polymer composite material according to the third aspect.

A seventh aspect of the present invention provides a method of preparing a carbon fiber-carbon nanomaterial-polymer composite material including impregnating a carbon fiber with a carbon nanomaterial-polymer composite material prepared by the method according to the fourth aspect.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1A schematically illustrates a functionalized carbon nanomaterial according to an embodiment of the present invention, wherein a functional molecule includes a part having affinity with a carbon nanomaterial and a part having affinity with a polymer matrix;

FIG. 1B illustrates a structural formula of a functional molecule, for example, poly-4-aminostyrene (PAS), which may be attached to a surface of a carbon nanomaterial using an aromatic hydrocarbon ring by π-π interactions and secure dispersibility in a solvent and bonding force to a polymer matrix through a terminal group —NH₂;

FIG. 2 schematically illustrates a process of preparing a carbon nanomaterial through mechanical milling according to an embodiment of the present invention;

FIG. 3 is a flowchart illustrating a process of functional a functionalized carbon nanomaterial through mechanical milling according to an embodiment of the present invention;

FIG. 4 is a flowchart illustrating a process of preparing a carbon nanomaterial-polymer composite material using a functionalized carbon nanomaterial according to an embodiment of the present invention;

FIG. 5A schematically illustrates a carbon fiber-carbon nanomaterial-polymer composite material according to an embodiment of the present invention;

FIG. 5B is a flowchart illustrating a process of preparing a carbon fiber-carbon nanomaterial-polymer composite material according to an embodiment of the present invention;

FIG. 6 illustrates Fourier transform-infrared spectroscopy (FT-IR) results of functionalized carbon nanomaterials according to an embodiment of the present invention, wherein a strong acid treated carbon nanotube (CNT) exhibits a characteristic peak by a C═O group formed by oxidation as compared with an unfunctionalized CNT, a PAS-CNT exhibits a characteristic peak by an N—H group, and a PSS-CNT exhibits a characteristic peak by an S═O group;

FIG. 7 illustrates Raman spectroscopic results of functionalized carbon nanomaterials according to the embodiment of the present invention, wherein an intensity ratio of a D-band by a diamond like structure to a G-band by a graphite like structure of a CNT, I_{D}/I_{G} ratio, is about 0.90 for an unfunctionalized CNT, about 0.98 for a strong acid treated CNT, 0.92 for a PAS-CNT and 0.94 for a PSS-CNT;

FIG. 8 illustrates pictures of tensile test specimens of carbon nanomaterial-polymer composite materials prepared according to an embodiment of the present invention;

FIG. 9A illustrates stress-strain curves of tensile test specimens of 1 wt % carbon nanomaterial-polymer composite materials prepared according to an embodiment of the present invention;

FIGS. 9B and 9C illustrate graphs Young's modulus and tensile strength of the tensile test specimens of the 1 wt % carbon nanomaterial-polymer composite materials according to an embodiment of the present invention;

FIG. 9D illustrates stress-strain curves of tensile test specimens of 1 wt % carbon nanomaterial-polymer composite materials prepared according to an embodiment of the present invention;

FIGS. 9E and 9F illustrate graphs Young's modulus and tensile strength of the tensile test specimens of the 1 wt % carbon nanomaterial-polymer composite materials prepared according to the embodiment of the present invention;

FIG. 9G illustrates a scanning electron microscopy (SEM) result of pure epoxy;

FIG. 9H illustrates an SEM result of unfunctionalized CNT-epoxy;

FIG. 9I illustrates an SEM result of PAS-CNT-epoxy according to an embodiment of the present invention;

FIG. 9J illustrates an SEM result of PSS-CNT-epoxy according to an embodiment of the present invention;

FIG. 10 is a picture of a sample of a carbon fiber-carbon nanomaterial-polymer composite material prepared according to an embodiment of the present invention;

FIG. 11 is a stress-strain curve of the carbon fiber-carbon nanomaterial-polymer composite material according to the embodiment of the present invention;

FIG. 12A is a stress-strain curve of a specimen of a carbon fiber-CNT-polymer composite material for a lateral shear strength test prepared according to an embodiment of the present invention;

FIG. 12B is a graph illustrating lateral shear strength of the specimen of the carbon fiber-CNT-polymer composite material according to the embodiment of the present invention;

FIG. 13A is a stress-strain curve of a specimen of a carbon fiber-CNT-polymer composite material for a fracture toughness test prepared according to an embodiment of the present invention; and

FIG. 13B is a graph illustrating fracture toughness of the specimen of the carbon fiber-CNT-polymer composite material according to the embodiment of the present invention.

### DETAILED DESCRIPTION

Hereinafter, exemplary embodiments of the present invention will be described in detail with reference to the accompanying drawings so that inventive concept may be readily implemented by those skilled in the art. However, the present invention may be embodied in different forms and should not be construed as limited to the embodiments set forth herein. In the drawings, certain parts not directly relevant to the description are omitted to enhance the clarity of the drawings, and like reference numerals denote like parts throughout the whole document.

It will be understood that when an element is referred to as being “connected to” another element, the element can be “directly connected to” another element or “electrically connected to” element via intervening elements.

It will be understood that when an element is referred to as being “on” another element, the element can be directly on another element or an intervening element.

Throughout the whole document, the term “comprises or includes” and/or “comprising or including” specify the presence of stated elements or components, but do not preclude the presence or addition of one or more other elements or components, unless mentioned otherwise.

The terms “about,” “approximately” or “substantially” used throughout the whole document are intended to have meanings close to numerical values or ranges specified with an allowable error and intended to prevent accurate or absolute numerical values disclosed for understanding of the present invention from being illegally or unfairly used by any unconscionable third party.

The terms “step” or “step of” used throughout the whole document does not mean “step for.”

Through the whole document, the term “combination(s) of” included in Markush type description means mixture or combinations of one or more components, steps, operations and/or elements selected from a group consisting of components, steps, operation and/or elements described in Markush type and thereby means that the disclosure includes one or more components, steps, operations and/or elements selected from the Markush group.

Throughout the whole document, the expression “A and/or B” refers to “A or B” or “A and B.”

In the specification, the term “alkyl group” may include linear or branched C1 to C10 alkyl group, C1 to C8 alkyl group, C1 to C6 alkyl group or C1 to C5 alkyl group, for example, methyl, ethyl, propyl, butyl, pentyl, hexyl, heptyl, octyl, nonyl, decyl or all possible isomers thereof, without being limited thereto.

Hereinafter, exemplary embodiments of the present invention will be described in detail, but the present invention may not be limited to the illustrated embodiments.

A first aspect of the present invention provides a carbon nanomaterial functionalized by a functional molecule including both an aromatic hydrocarbon ring and a polar group through mechanical milling.

The carbon nanomaterial may include a functionalized carbon nanotube (CNT), a functionalized carbon fiber, a functionalized carbon nanorod or a functionalized graphene, without being limited thereto.

Functionalization may be noncovalent functionalization, without being limited thereto.

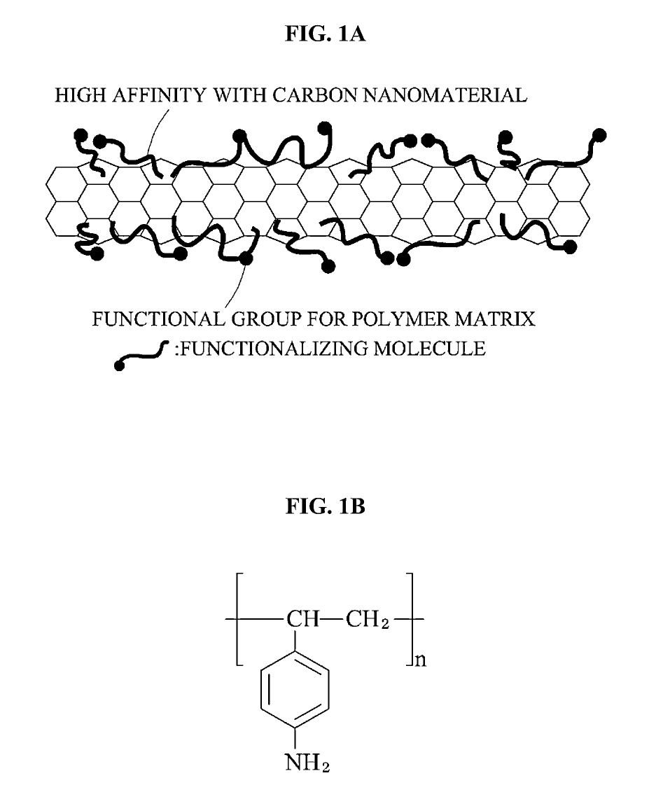

The functionalized carbon nanomaterial is prepared through mechanical milling. FIG. 1A schematically illustrates a functionalized carbon nanomaterial according to an embodiment of the present invention, in which a functional molecule includes a part having affinity with a carbon nanomaterial and a part having affinity with a polymer matrix.

The functional molecule used for functionalization may include both an aromatic hydrocarbon ring and a polar group, without being limited thereto. FIG. 1B illustrates a structural formula of the functional molecule, for example, poly-4-aminostyrene (PAS). As shown in FIG. 1B, the functional molecule may include a noncovalent functional molecule, wherein the noncovalent functional molecule may be attached to a surface of the carbon nanomaterial using the aromatic hydrocarbon ring by π-π interactions and secure dispersibility in a solvent through the polar group.

The polar functional group may include at least one selected from the group consisting of —NH₂, —OH, —SO₃⁻, an amide group (—CONH₂), an amide group substituted with a C1 to C10 alkyl group (—CONHR), a halo group, a carbonyl group substituted with a C1 to C10 alkyl group (—COR), an aldehyde group (—COH), a carboxyl group (—COOH), an ester group substituted with a C1 to C10 alkyl group (—COOR), a nitrile group (—CN) and a nitro group (—NO₂), without being limited thereto.

The functional molecule may be selected from materials capable of forming a covalent bond directly with the polymer matrix through the polar group thereof. When the polymer matrix, the carbon nanomaterial and the functional molecule are mixed, the functional molecule strongly couples the polymer matrix and the carbon nanomaterial to smoothly transfer stress between the polymer matrix and the carbon nanomaterial.

Unrestricted examples of the functional molecule used for functionalization may include poly-4-aminostyrene (PAS), polystyrene sulfonate (PSS), polyphenol, halogenated polyphenylen and nitro polypheylene, without being limited thereto.

A second aspect of the present invention provides a method of preparing a carbon nanomaterial, the method including forming a mixture by mixing a functional molecule including both an aromatic hydrocarbon ring and a polar functional group with a carbon nanomaterial, and obtaining a functionalized carbon nanomaterial by conducting mechanical milling on the mixture.

Functionalization of the carbon nanomaterial through mechanical milling preferentially performed may enable minimization of defects in the carbon nanomaterial, massive functionalization of carbon nanomaterials and effective decrease in functional time, as compared with a conventional noncovalent functionalization method using strong acid treatment.

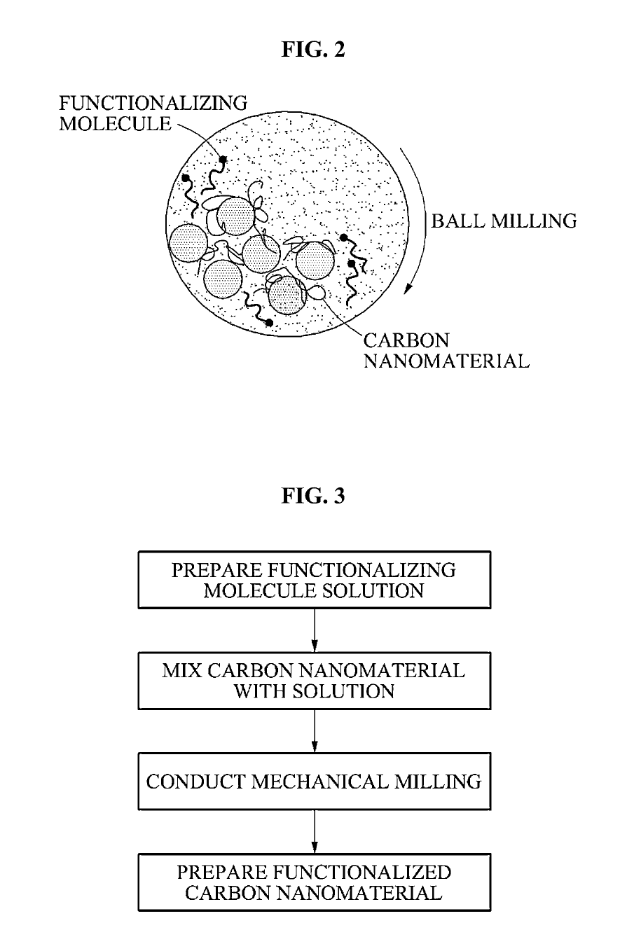

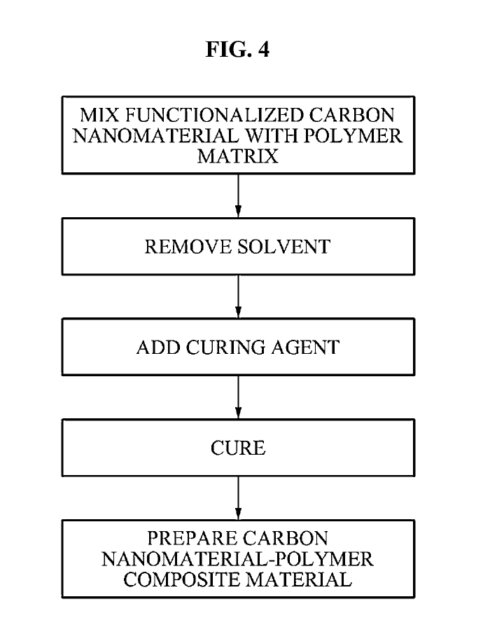

FIG. 2 schematically illustrates a process of preparing a carbon nanomaterial functionalized through mechanical milling according to an embodiment of the present invention, and FIG. 3 is a flowchart illustrating a process of functional a functionalized carbon nanomaterial through mechanical milling according to an embodiment of the present invention.

As illustrated in FIGS. 2 and 3, a carbon nanomaterial and a functional molecule are mixed and subjected to mechanical milling, thereby easily preparing a functionalized carbon nanomaterial. First, the functional molecule is dissolved in a solvent to prepare a functional molecule solution, which is mixed with the carbon nanomaterial, for example, CNT, carbon nanoload or carbon nanofiber, thereby preparing a mixture solution. Here, mixing may be conducted through stirring and/or ultrasonic processing. Subsequently, the mixture solution is subjected to mechanical milling, for example, ball milling, to attach a functional group to a surface of the carbon nanomaterial, thereby producing a functionalized carbon nanomaterial. The produced functionalized carbon nanomaterial may be subjected to filtering and drying to obtain a powdery form.

Unrestricted examples of the solvent may include aprotic solvents, such as N,N-dimethylforamide, N-methyl-2-pyrrolidone and acetone; alcoholic solvents, such as water, ethyl alcohol, propanol and butanol; and protic solvents, such as ethylene glycol, without being limited thereto.

The mechanical milling may include ball milling, planetary milling, attrition milling, jet milling or bead milling, without being limited thereto.

Functionalization may include noncovalent functionalization, without being limited thereto.

The functional molecule used for functionalization may include both an aromatic hydrocarbon ring and a polar group, without being limited thereto. The functional molecule may include a noncovalent functional molecule, wherein the noncovalent functional molecule may be attached to the surface of the carbon nanomaterial using the aromatic hydrocarbon ring by π-π interactions and secure dispersibility in a solvent through the polar group.

The polar functional group may include at least one selected from the group consisting of —NH₂, —OH, —SO₃⁻, an amide group (—CONH₂), an amide group substituted with a C1 to C10 alkyl group (—CONHR), a halo group, a carbonyl group substituted with a C1 to C10 alkyl group (—COR), an aldehyde group (—COH), a carboxyl group (—COOH), an ester group substituted with a C1 to C10 alkyl group (—COOR), a nitrile group (—CN) and a nitro group (—NO₂), without being limited thereto.

The functional molecule may be selected from materials capable of forming a covalent bond directly with the polymer matrix through the polar group thereof. When the polymer matrix, the carbon nanomaterial and the functional molecule are mixed, the functional molecule strongly couples the polymer matrix and the carbon nanomaterial to smoothly transfer stress between the polymer matrix and the carbon nanomaterial.

Unrestricted examples of the functional molecule used for functionalization may include poly-4-aminostyrene (PAS), polystyrene sulfonate (PSS), polyphenol, halogenated polyphenylen and nitro polypheylene, without being limited thereto.

The carbon nanomaterial may include a functionalized CNT, a functionalized carbon fiber, a functionalized carbon nanorod or a functionalized graphene, without being limited thereto.

A third aspect of the present invention provides a carbon nanomaterial-polymer composite material including a polymer matrix and the carbon nanomaterial according to the first aspect.

The carbon nanomaterial may be present in an amount of about 10% by weight (wt %) or less based on a total weight of the carbon nanomaterial-polymer composite material, without being limited thereto. For example, the carbon nanomaterial may be present in an amount of about 0.1 wt % to about 10 wt %, about 0.1 wt % to about 8 wt %, about 0.1 wt % to about 5 wt %, about 0.1 wt % to about 3 wt %, about 0.1 wt % to about 1 wt %, about 0.1 wt % to about 0.5 wt %, about 0.5 wt % to about 10 wt %, about 1 wt % to about 10 wt %, about 3 wt % to about 10 wt %, about 5 wt % to about 10 wt %, or about 8 wt % to about 10 wt % based on the total weight of the carbon nanomaterial-polymer composite material, without being limited thereto.

The polymer matrix may include a thermosetting polymer or a thermoplastic polymer, without being limited thereto.

The thermosetting polymer may include at least one selected from the group consisting of an epoxy resin, a phenolic resin, a urethane resin and an unsaturated ester resin, without being limited thereto.

The thermoplastic polymer may include at least one selected from the group consisting of a nylon resin, a polyester resin and a polycarbonate resin, without being limited thereto.

The third aspect of the present invention relates to the carbon nanomaterial-polymer composite material, in which detailed descriptions overlapping with those of the first and second aspects are omitted but the same descriptions of the first and second aspects may also be applied to the third aspect although not mentioned in the third aspect.

A fourth aspect of the present invention provides a method of preparing a carbon nanomaterial-polymer composite material including mixing a carbon nanomaterial prepared by the method according to the second aspect with a polymer matrix.

The method of preparing the carbon nanomaterial-polymer composite material may include mixing the carbon nanomaterial according to the first aspect with a polymer matrix.

The carbon nanomaterial may be present in an amount of about 10 wt % or less based on a total weight of the carbon nanomaterial-polymer composite material, without being limited thereto. For example, the carbon nanomaterial may be present in an amount of about 0.1 wt % to about 10 wt %, about 0.1 wt % to about 8 wt %, about 0.1 wt % to about 5 wt %, about 0.1 wt % to about 3 wt %, about 0.1 wt % to about 1 wt %, about 0.1 wt % to about 0.5 wt %, about 0.5 wt % to about 10 wt %, about 1 wt % to about 10 wt %, about 3 wt % to about 10 wt %, about 5 wt % to about 10 wt %, or about 8 wt % to about 10 wt % based on the total weight of the carbon nanomaterial-polymer composite material, without being limited thereto.

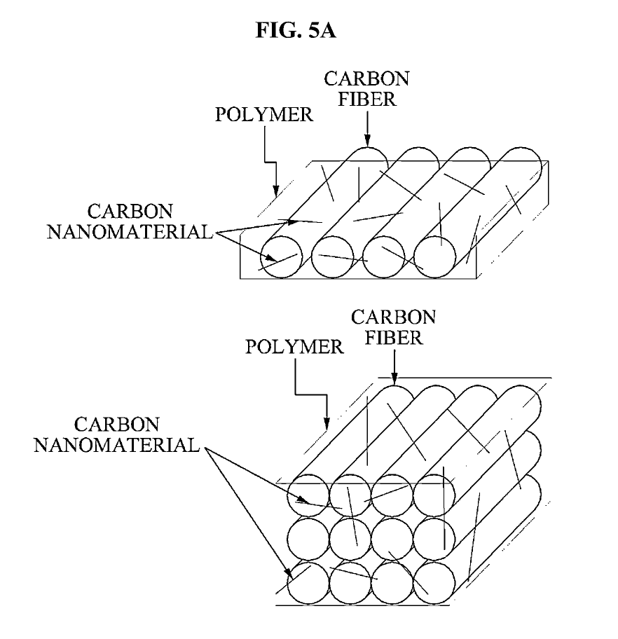

The method of preparing the carbon nanomaterial-polymer composite material may be conducted according to a process illustrated in FIG. 4. FIG. 4 is a flowchart illustrating a process of preparing a carbon nanomaterial-polymer composite material using a functionalized CNT according to an embodiment of the present invention.

As shown in FIG. 4, a functionalized carbon nanomaterial, for example, CNT, and a polymer matrix, for example, epoxy resin, are mixed in a solvent to prepare a mixture solution. Here, mixing may be conducted through stirring and/or ultrasonic processing. Subsequently, the solvent is evaporated from the mixture solution, after which a curing agent is added to the remaining mixture, followed by degasification in a vacuum and curing, thereby preparing a carbon nanomaterial-polymer composite material, for example, CNT-epoxy resin.

Unrestricted examples of the solvent may include aprotic solvents, such as N,N-dimethylforamide, N-methyl-2-pyrrolidone and acetone; alcoholic solvents, such as water, ethyl alcohol, propanol and butanol; and protic solvents, such as ethylene glycol, without being limited thereto.

The carbon nanomaterial-polymer composite material may be prepared by simple mixing, solution mixing or melt mixing, without being limited thereto.

The mixing may further include adding a curing agent, without being limited thereto.

The curing agent may include polyamides, alicyclic amines, phenalkamines, aromatic amines, acid anhydrides or dicyandiamides, without being limited thereto.

The fourth aspect of the present invention relates to the method of preparing the carbon nanomaterial-polymer composite material, in which detailed descriptions overlapping with those of the first to third aspects are omitted but the same descriptions of the first to third aspects may also be applied to the fourth aspect although not mentioned in the fourth aspect.

A fifth aspect of the present invention provides a carbon fiber-carbon nanomaterial-polymer composite material including a carbon fiber and the carbon nanomaterial-polymer composite material according to the third aspect.

The carbon nanomaterial-polymer composite material may include the carbon fiber and a polymer at a weight ratio of about 1:1 to about 6:4, without being limited thereto.

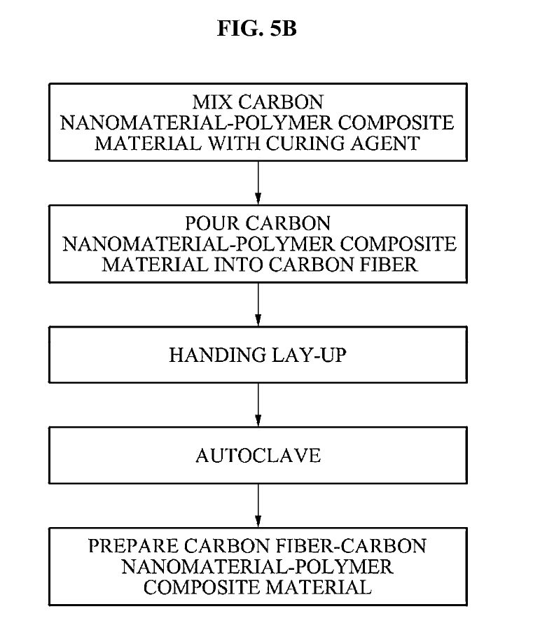

FIG. 5A schematically illustrates a carbon fiber-carbon nanomaterial-polymer composite material according to an embodiment of the present invention.

As shown in FIG. 5A, the carbon fiber-carbon nanomaterial-polymer composite material may have a single-layer or multilayer structure, without being limited thereto.

The carbon fiber-carbon nanomaterial-polymer composite material prepared by impregnating the carbon fiber with the carbon nanomaterial-polymer composite material has excellent mechanical properties as compared with conventional carbon fiber-polymer composite materials. Particularly, the carbon fiber-carbon nanomaterial-polymer composite material according to the present invention may effectively prevent delamination in a carbon fiber-polymer composite material, which occurs in conventional carbon fiber-polymer composite materials due to anisotropy by difference in mechanical properties between a carbon fiber and a polymer matrix and low bond strength between the carbon fiber and the polymer matrix

The fifth aspect of the present invention relates to the carbon fiber-carbon nanomaterial-polymer composite material, in which detailed descriptions overlapping with those of the first to fourth aspects are omitted but the same descriptions of the first to fourth aspects may also be applied to the fifth aspect although not mentioned in the fifth aspect.

A sixth aspect of the present invention provides a method of preparing a carbon fiber-carbon nanomaterial-polymer composite material including impregnating a carbon fiber with the carbon nanomaterial-polymer composite material according to the third aspect.

The method of preparing the carbon fiber-carbon nanomaterial-polymer composite material may include impregnating a carbon fiber with a carbon nanomaterial-polymer composite material prepared by the method according to the fourth aspect.

The carbon nanomaterial-polymer composite material may include the carbon fiber and a polymer at a weight ratio of about 1:1 to about 6:4, without being limited thereto.

FIG. 5B is a flowchart illustrating a process of preparing a carbon fiber-carbon nanomaterial-polymer composite material according to an embodiment of the present invention.

As shown in FIG. 5B, a carbon nanomaterial-polymer composite material and a curing agent are mixed and poured into a carbon fiber to impregnate the carbon fiber with a polymer matrix, for example, epoxy resin, by handing lay-up. Handing lay-up refers to a process of infiltrating the polymer matrix into the carbon fiber using a roller or brush. First, felt or unidirectional carbon fiber is placed on a release film, and the polymer matrix is poured thereon and is thoroughly infiltrated into the carbon fiber using a roller and a brush. This process may be repeated to a desired thickness of a carbon fiber layer. The carbon fiber impregnated with the carbon nanomaterial-polymer composite material is degasified in a vacuum and processed in an autoclave, thereby producing a carbon fiber-carbon nanomaterial-polymer composite material.

The carbon fiber-carbon nanomaterial-polymer composite material may acquire superior mechanical properties, as compared with conventional carbon fiber-polymer composite materials, by impregnating the stacked carbon fiber with the carbon nanomaterial-polymer composite material.

The sixth aspect of the present invention relates to the method of preparing the carbon fiber-carbon nanomaterial-polymer composite material, in which detailed descriptions overlapping with those of the first to fifth aspects are omitted but the same descriptions of the first to fifth aspects may also be applied to the sixth aspect although not mentioned in the sixth aspect.

According to one embodiment of the present invention, a chemical functional group is introduced to a surface of a carbon nanomaterial to resolve a dispersion issue of the carbon nanomaterial and is designed to form a strong covalent bond with a matrix material, thereby producing a carbon nanomaterial composite with excellent mechanical properties. In addition, while a solution-based chemical functionalization process conventionally used causes a considerable defect in a carbon nanomaterial and requires a great amount of time for chemical reactions and washing, mixing a carbon nanomaterial with a functional molecule through mechanical milling enables easy introduction of the functional molecule to a surface of the carbon nanomaterial, thus preparing a composite material including a carbon nanomaterial, a polymer and a carbon fiber.

Hereinafter, the present invention will be explained in more detail with reference to the following examples. These examples, however, are illustrated for easier understanding only and are not to be construed as limiting the present invention.

### EXAMPLES

### Example 1

### Preparation of Functionalized Carbon Nanomaterial (PAS-CNT)

Poly-4-aminostyrene (PAS, Polysciences, USA, 300 mg, room temperature) was dissolved in N,N-dimethylforamide as a solvent to prepare a PAS solution as a functional molecule solution, which is mixed with a CNT (Hanwha Chemical, Korea, 700 mg), thereby preparing a mixture solution. The mixture solution was subjected to ball milling (200 rpm, 24 hours), filtered for 30 minutes, and dried at room temperature in a vacuum, thereby producing PAS-CNT powder.

### Example 2

### Preparation of Functionalized Carbon Nanomaterial (PAS-CNT)

Polystyrene sulfonate (PSS, Sigma Aldrich, USA, 300 mg, room temperature) was dissolved in N,N-dimethylforamide as a solvent to prepare a PSS solution as a functional molecule solution, which is mixed with a CNT (Hanwha Chemical, Korea, 700 mg), thereby preparing a mixture solution. The mixture solution was subjected to ball milling (200 rpm, 24 hours), filtered for 30 minutes, and dried at room temperature in a vacuum, thereby producing PSS-CNT powder.

FIG. 6 is a graph illustrating Fourier transform-infrared spectroscopy (FT-IR) results of an unfunctionalized CNT (pure CNT), a CNT functionalized through strong acid treatment (acid treated CNT), the PAS-CNT prepared in Example 1 and the PSS-CNT prepared in Example 2. As shown in FIG. 6, the strong acid treated CNT exhibits a characteristic peak by a C═O group formed by oxidation as compared with the unfunctionalized CNT, the PAS-CNT exhibits a characteristic peak by an N—H group, and the PSS-CNT exhibits a characteristic peak by an S═O group. The results show that the functional molecules are successfully introduced to the surfaces of the CNTs.

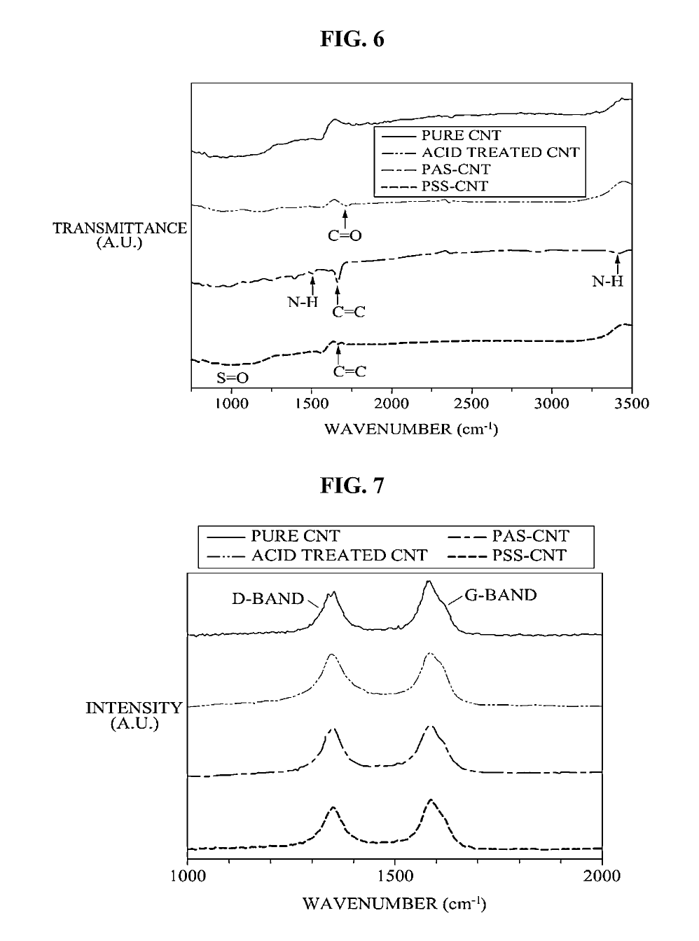

FIG. 7 illustrates Raman spectroscopic results of the functionalized CNTs according to the examples. FIG. 7 shows that crystallization of the CNTs changes on functionalization and an intensity ratio of a D-band by a diamond like structure to a G-band by a graphite like structure of a CNT, I_{D}/I_{G} ratio, is about 0.90 for the unfunctionalized CNT, about 0.98 for the strong acid treated CNT, 0.92 for the PAS-CNT and 0.94 for the PSS-CNT (in FIG. 7, the D-band is in a range of about 1300 cm⁻¹ to about 1400 cm⁻¹, and the G-band is in a range of about 1600 cm⁻¹). Generally, I_{D}/I_{G} ratio increases as a CNT changes from a graphite structure to a diamond structure by defects caused in functionalization. The forgoing results show that functionalization through mechanical milling according to the present invention is a method for minimizing defects in a CNT which may occur during functionalization.

### Example 3

### Preparation of Carbon Nanomaterial-Polymer Composite Material (PAS-CNT-Epoxy Composite Material)

The PAS-CNT prepared in Example 1 and an epoxy resin (KFR-120, Kukdo Chemical, Korea, 3.05 g) were mixed in a solvent of N,N-dimethylforamide and acetone to prepare a mixture solution. The solvent was evaporated from the mixture solution, after which a curing agent (amine curing agent, KFH-163, Kukdo Chemical, Korea, 0.91 g) was added to the remaining mixture, followed by degasification in a vacuum and curing, thereby preparing a PAS-CNT-epoxy composite material containing a 1 wt % PAS-CNT.

### Example 4

### Preparation of Carbon Nanomaterial-Polymer Composite Material (PSS-CNT-Epoxy Composite Material)

The PSS-CNT prepared in Example 2 and an epoxy resin (KFR-120, Kukdo Chemical, Korea, 3.05 g) were mixed in a solvent of N,N-dimethylforamide and acetone to prepare a mixture solution. The solvent was evaporated from the mixture solution, after which a curing agent (amine curing agent, KFH-163, Kukdo Chemical, Korea, 0.91 g) was added to the remaining mixture, followed by degasification in a vacuum and curing, thereby preparing a PSS-CNT-epoxy composite material containing a 1 wt % PSS-CNT.

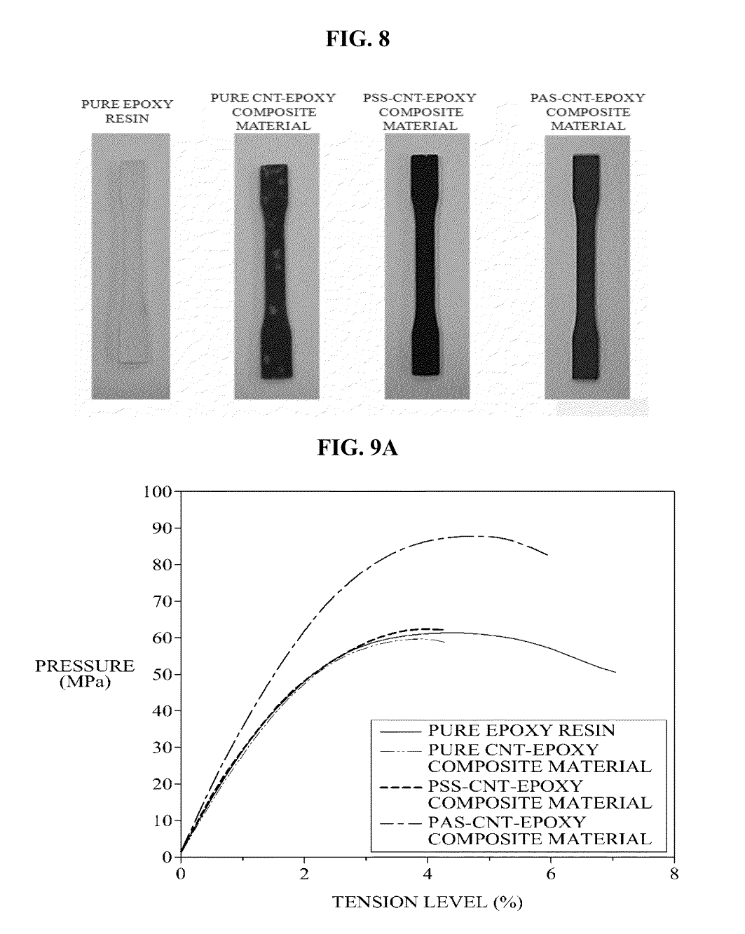

FIG. 8 illustrates pictures of tensile test specimens of the carbon nanomaterial-polymer composite materials prepared in the examples. As illustrated in FIG. 8, pure epoxy is semi-transparent yellow, while CNT-epoxy composite materials are black overall. Specifically, an unfunctionalized CNT-epoxy composite material is partly yellow due to non-uniform dispersion of CNTs, whereas a specimen of the PAS-CNT-epoxy composite material obtained in Example 3 is black overall due to uniform dispersion of CNTs and the PSS-CNT-epoxy composite material obtained in Example 4 is uniformly dark grey overall.

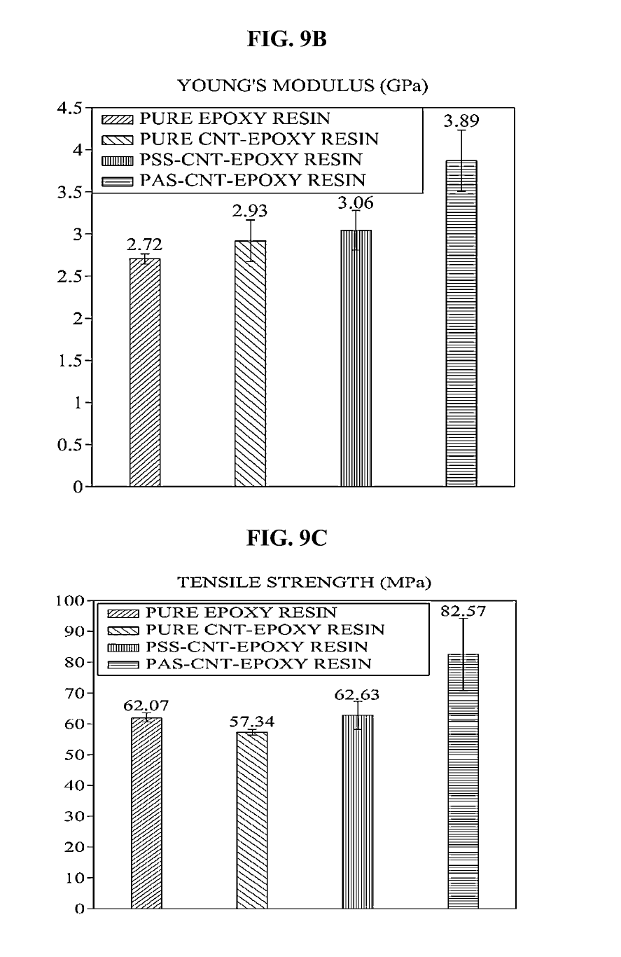

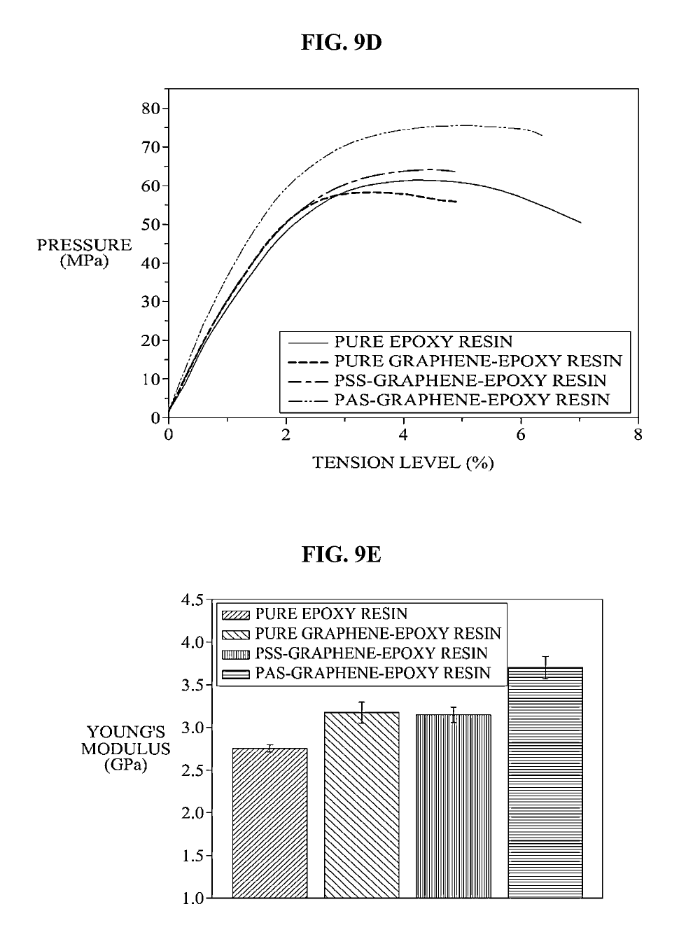

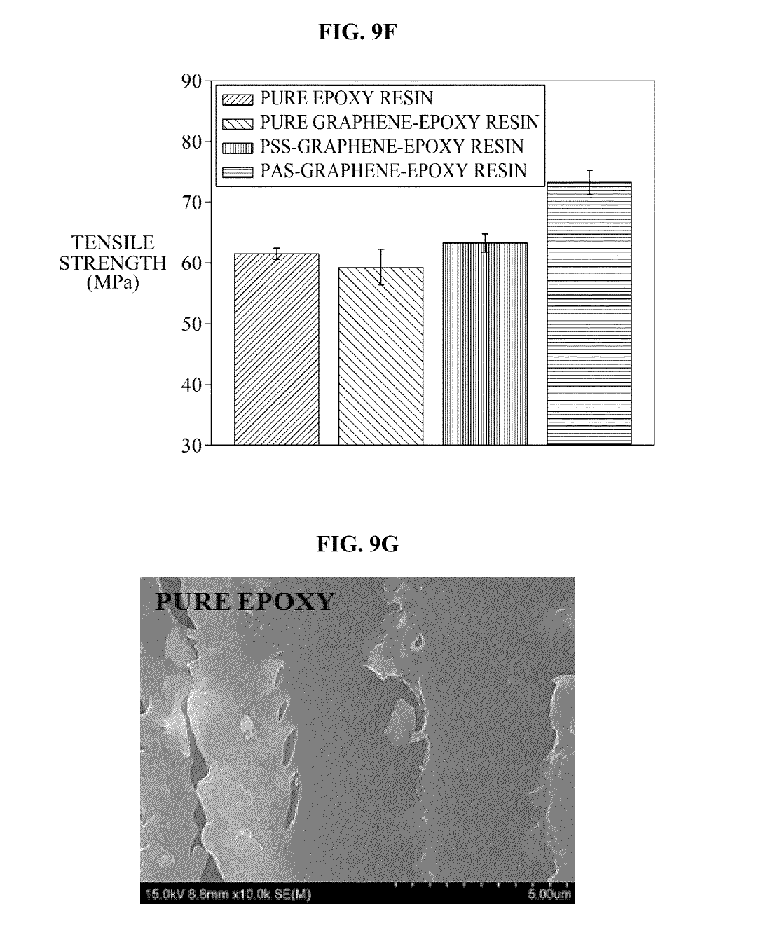

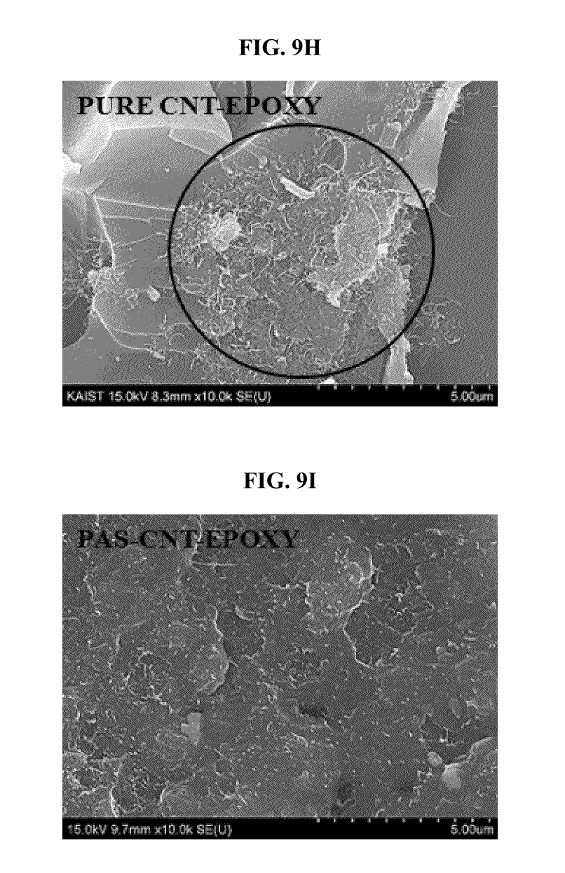

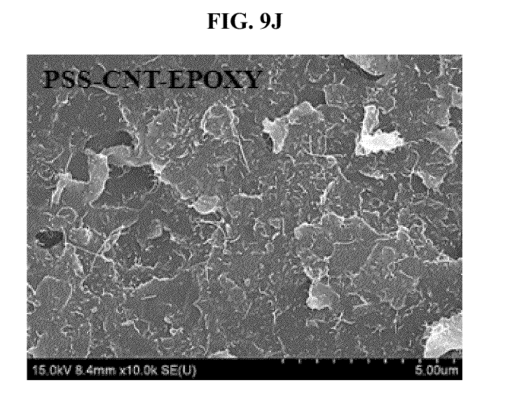

FIG. 9A illustrates stress-strain curves of tensile test specimens of the 1 wt % carbon nanomaterial-polymer composite materials prepared in the examples, and FIGS. 9B and 9C illustrates graphs Young's modulus and tensile strength of the tensile test specimens of the 1 wt % carbon nanomaterial-polymer composite materials prepared in the examples. As shown in FIGS. 9A to 9C, Young's modulus of the unfunctionalized CNT-epoxy composite material is slightly increased, and tensile strength thereof is rather reduced. This result is considered to be due to that non-uniform dispersion of CNTs limits performance of the composite material. Meanwhile, the PSS-CNT-epoxy composite material from Example 4 has a Young's modulus of 3.06 Pa and a tensile strength of 62.63 MPa, respectively increased from 2.72 Pa and 62.07 MPa of pure epoxy. In particular, the PAS-CNT-epoxy composite material prepared in Example 3 has a Young's modulus increased by about 43% and a tensile strength increased by about 33% as compared with those of pure epoxy. This result is considered to be due to that —NH₂ as a functional group of the PAS-CNT forms a covalent bond directly with epoxy as the polymer matrix to strongly couple CNTs and epoxy as compared with —SO₃⁻ as a functional group of the PSS-CNT.

FIG. 9D illustrates stress-strain curves of tensile test specimens of 1 wt % carbon nanomaterial-polymer composite materials prepared according to an embodiment of the present invention, and FIGS. 9E and 9F illustrates graphs Young's modulus and tensile strength of the tensile test specimens of the 1 wt % carbon nanomaterial-polymer composite materials prepared according to the embodiment.

As shown in FIGS. 9D to 9F, Young's modulus of an unfunctionalized graphene-epoxy composite material is slightly increased, and tensile strength thereof is rather reduced. This result is considered to be due to that non-uniform dispersion of CNTs limits performance of the composite material. Meanwhile, a PSS-graphene-epoxy composite material prepared in the embodiment has a Young's modulus of 3.15 Pa and a tensile strength of 63.26 MPa, respectively increased from 2.72 Pa and 62.07 MPa of pure epoxy. In particular, a PAS-graphene-epoxy composite material prepared in the embodiment has a Young's modulus increased by about 34% and a tensile strength increased by about 20% as compared with those of pure epoxy. This result is considered to be due to that —NH₂ as a functional group of PAS-graphene forms a covalent bond directly with epoxy as a polymer matrix to strongly couple CNTs and epoxy as compared with —SO₃⁻ as a functional group of PSS-graphene.

FIGS. 9G to 9J illustrate scanning electron microscopy (SEM) results of pure epoxy, unfunctionalized CNT-epoxy (pure CNT-epoxy), PAS-CNT-epoxy in Example 3 and PSS-CNT-epoxy in Example 4. FIG. 9H shows that unfunctionalized CNTs are non-uniformly dispersed in epoxy. On the contrary, FIGS. 9I and 9J show that PAS-CNTs and PSS-CNTs are uniformly dispersed in epoxy.

### Example 5

### Preparation of Carbon Fiber-Carbon Nanomaterial-Polymer Composite Material (CF-PAS-CNT-Epoxy Composite Material)

The PAS-CNT-epoxy composite material prepared in Example 3 and a curing agent (amine curing agent, KFH-163, Kukdo Chemical, Korea, 1.37 g) were mixed and poured into a carbon fiber (CF) to impregnate the carbon fiber with the PAS-CNT-epoxy composite material by handing lay-up. The carbon fiber impregnated with the carbon nanomaterial-polymer composite material was degasified at 65° C. in a vacuum and processed at 110° C. and 6 bar in an autoclave, thereby producing a CF-PAS-CNT-epoxy composite material.

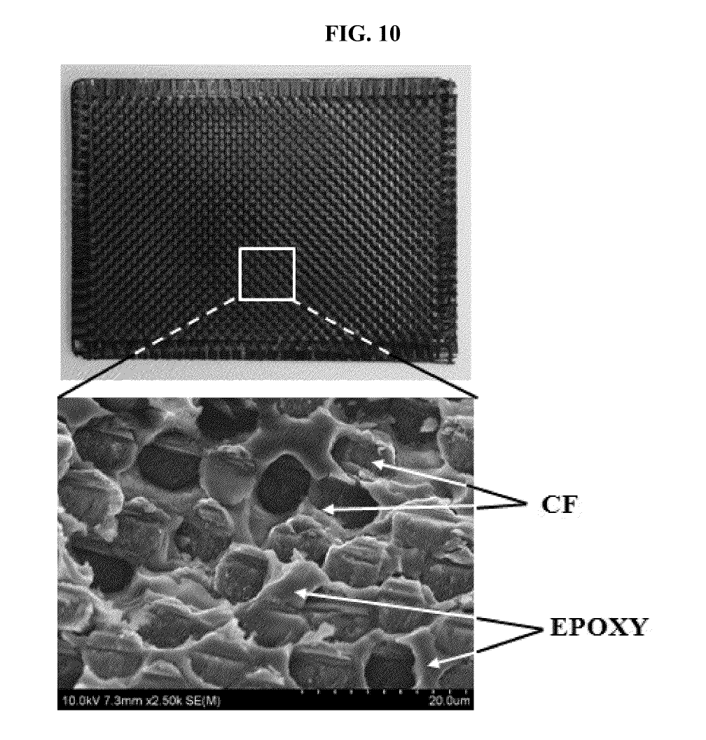

FIG. 10 is a picture of a sample of the carbon fiber-carbon nanomaterial-polymer composite material prepared in the example. As shown in FIG. 10, the CF-PAS-CNT-epoxy composite material according to Example 5 is uniformly black overall, in which carbon fibers are impregnated with epoxy.

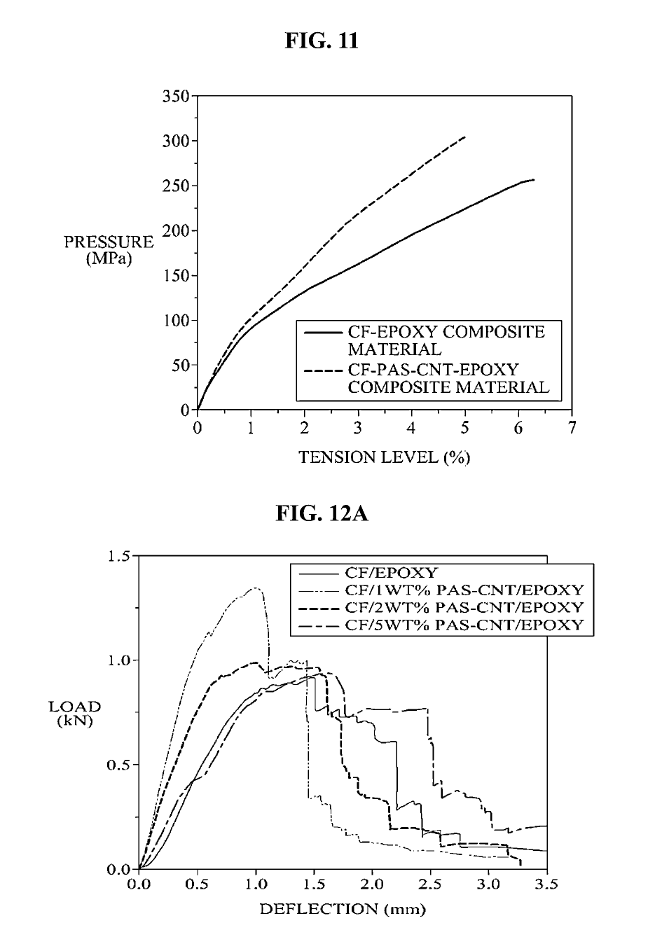

FIG. 11 is a stress-strain curve of the carbon fiber-carbon nanomaterial-polymer composite material according to the example. FIG. 11 shows that the CF-PAS-CNT-epoxy composite material according to Example 5 has a Young's modulus increased by about 4% and a tensile strength increased by about 16% as compared with those of a carbon fiber-epoxy composite material.

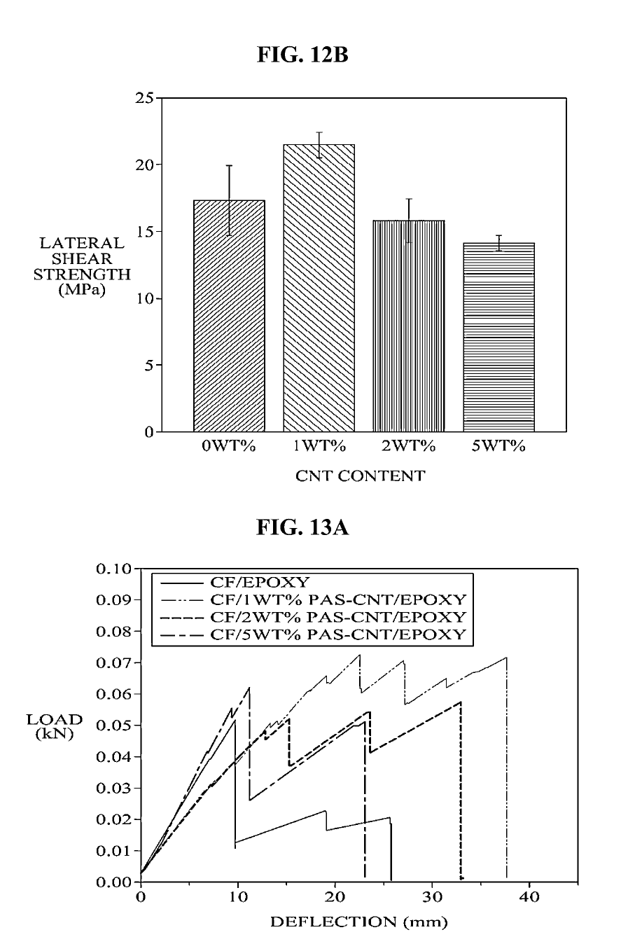

FIG. 12A is a stress-strain curve of a specimen of a carbon fiber-CNT-polymer composite material for a lateral shear strength test prepared according to an embodiment of the present invention, and FIG. 12B is a graph illustrating lateral shear strength of the specimen of the carbon fiber-CNT-polymer composite material according to the embodiment.

FIG. 12B shows that the PAS-CNT-epoxy composite material including a 1 wt % PAS-CNT has a lateral shear strength increased by about 24% as compared with that of a carbon fiber-epoxy composite material.

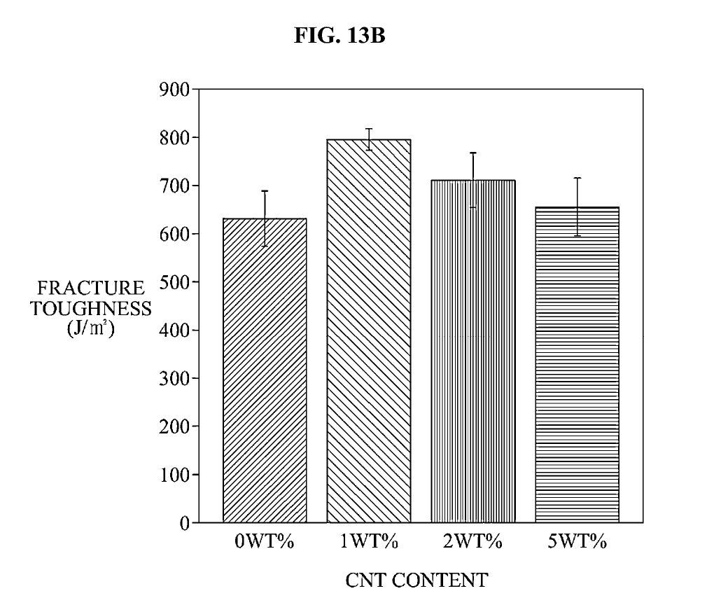

FIG. 13A is a stress-strain curve of a specimen of a carbon fiber-CNT-polymer composite material for a fracture toughness test prepared according to an embodiment of the present invention, and FIG. 13B is a graph illustrating fracture toughness of the specimen of the carbon fiber-CNT-polymer composite material according to the embodiment.

FIG. 13B shows that the PAS-CNT-epoxy composite material including a 1 wt % PAS-CNT has a fracture toughness increased by about 26% as compared with that of a carbon fiber-epoxy composite material.

As described above, a carbon nanomaterial functionalized through mechanical milling according to an embodiment of the present invention may minimize defects in the carbon nanomaterial, massively functionalize carbon nanomaterials, and effectively reduce functionalization time.

The present invention includes a process of preparing a functionalized carbon nanomaterial through mechanical milling to effectively reduce functionalization time, thereby quickly preparing a carbon nanomaterial-polymer composite material. In addition, a terminal group of a functionalization molecule is designed to form a strong covalent bond directly with a polymer matrix to induce a chemical bond between the polymer matrix and the carbon nanomaterial, thus achieving effective stress transfer and preparing a carbon nanomaterial-polymer composite material with high mechanical strength. Moreover, the carbon nanomaterial-polymer composite material is applied to a carbon fiber to effectively prevent delamination between a carbon fiber and a polymer of a carbon fiber-polymer composite material which conventionally occurs.

The foregoing description of the present invention is for illustrative purpose, and it would be appreciated by those having ordinary knowledge in the art to which the present invention pertains that various modifications and variations can be made from the foregoing descriptions without changing technical ideas or essential features of the present invention. Therefore, the aforementioned embodiments are construed as not being restrictive but being illustrative. For example, elements mentioned in a single form may be realized in a distributed manner, and distributed elements may be realized in a combined form.

The scope of the present invention is defined by the appended claims, and all variations and modifications made from the meanings and scope of the claims and their equivalents are construed as being included in the scope of the present invention.

What is claimed is:

1. A carbon nanomaterial functionalized by a functional molecule comprising both an aromatic hydrocarbon ring and a polar group through mechanical milling.

2. The carbon nanomaterial of claim 1, wherein the mechanical milling comprises ball milling, planetary milling, attrition milling, jet milling, or bead milling.

3. The carbon nanomaterial of claim 1, wherein the polar group comprises at least one selected from —NH₂, —OH, —SO₃⁻, an amide group (—CONH₂), an amide group substituted with a C1 to C10 alkyl group (—CONHR), a halo group, a carbonyl group substituted with a C1 to C10 alkyl group (—COR), an aldehyde group (—COH), a carboxyl group (—COOH), an ester group substituted with a C1 to C10 alkyl group (—COOR), a nitrile group (—CN), and a nitro group (—NO₂).

4. The carbon nanomaterial of claim 1, wherein the carbon nanomaterial comprises a functionalized carbon nanotube, a functionalized carbon fiber, a functionalized carbon nanorod, or a functionalized graphene.

5. A method of preparing a carbon nanomaterial, the method comprising:
forming a mixture by mixing a functional molecule comprising both an aromatic hydrocarbon ring and a polar group with a carbon nanomaterial; and
acquiring a functionalized carbon nanomaterial by conducting mechanical milling on the mixture.

6. The method of claim 5, wherein the polar group comprises at least one selected from —NH₂, —OH, —SO₃⁻, an amide group (—CONH₂), an amide group substituted with a C1 to C10 alkyl group (—CONHR), a halo group, a carbonyl group substituted with a C1 to C10 alkyl group (—COR), an aldehyde group (—COH), a carboxyl group (—COOH), an ester group substituted with a C1 to C10 alkyl group (—COOR), a nitrile group (—CN), and a nitro group (—NO₂).

7. The method of claim 5, wherein the functionalized carbon nanomaterial comprises a functionalized carbon nanotube, a functionalized carbon fiber, a functionalized carbon nanorod, or a functionalized graphene.

8. The method of claim 5, wherein the mechanical milling comprises ball milling, planetary milling, attrition milling, jet milling, or bead milling.

9. A carbon nanomaterial-polymer composite material comprising:
a polymer matrix; and
the carbon nanomaterial of claim 1.

10. The carbon nanomaterial-polymer composite material of claim 9, wherein the polymer matrix comprises a thermosetting polymer or a thermoplastic polymer.

11. The carbon nanomaterial-polymer composite material of claim 10, wherein the thermosetting polymer comprises at least one selected from an epoxy resin, a phenolic resin, a urethane resin, and an unsaturated ester resin.

12. The carbon nanomaterial-polymer composite material of claim 10, wherein the thermoplastic polymer comprises at least one selected from a nylon resin, a polyester resin, and a polycarbonate resin.

13. A method of preparing a carbon nanomaterial-polymer composite material, the method comprising:
mixing a carbon nanomaterial prepared by the method of claim 5 with a polymer matrix.

14. The method of claim 13, wherein the mixing further comprises adding a curing agent.

15. A carbon fiber-carbon nanomaterial-polymer composite material comprising:
a carbon fiber; and
the carbon nanomaterial-polymer composite material of claim 9.

16. The carbon fiber-carbon nanomaterial-polymer composite material of claim 15, wherein the carbon fiber-carbon nanomaterial-polymer composite material has a single-layer structure.

17. A method of preparing a carbon fiber-carbon nanomaterial-polymer composite material comprising:
impregnating a carbon fiber with the carbon nanomaterial-polymer composite material of claim 9.

18. A method of preparing a carbon fiber-carbon nanomaterial-polymer composite material comprising:
impregnating a carbon fiber with a carbon nanomaterial-polymer composite material prepared by the method of claim 13.

19. The carbon fiber-carbon nanomaterial-polymer composite material of claim 15, wherein the carbon fiber-carbon nanomaterial-polymer composite material has a multilayer structure.
